(19) United States
(12) Patent Application Publication
(10) Pub. No.: US 2018/0118139 A1
(43) Pub. Date: May 3, 2018

(54) TRUCK REFRIGERATION UNIT SHIELD

(71) Applicant: EDUARDO GARCIA, BAKERSFIELD, CA (US)

(72) Inventor: EDUARDO GARCIA, BAKERSFIELD, CA (US)

(21) Appl. No.: 15/339,761

(22) Filed: Oct. 31, 2016

(51) Int. Cl. B60R 19/02; B60P 3/20; B62D 35/00; B60R 19/24

(52) U.S. Cl. CPC B60R 19/023; B60R 19/24; B62D 35/00; B60P 3/20

(57) ABSTRACT

An outer protective cover for shielding the refrigeration unit that prevents the forklifts from damaging the refrigeration units. The outer protective cover for shielding the refrigeration unit is made of metal and bolted thereby covering the refrigeration unit.

### BACKGROUND OF THE INVENTION

### (1) Field of the Invention

The present invention generally relates to refrigeration units. More particularly the invention relates to a shield or outer protective cover that covers the refrigeration unit.

### (2) Background of the Invention

A typical transport refrigeration unit of the type designed for mounting on the front face of a tractor trailer unit comprises a one-piece, self-contained fully refrigerant charged, pre-wired, refrigerant/heating unit powered by a diesel engine. In such a design, the evaporator section fits into a rectangular opening in the upper portion of the trailer front wall. When installed, the evaporator section is located inside the trailer and the condensing section is outside and on the front of the trailer. The condensing section consists of an engine-compressor drive package, condenser fan, condenser coil, radiator coil, control panel, relay module, refrigerant controls, piping, wiring and associated components.

Structural frame members support all of the components and facilitate attaching the unit to the trailer front face. Also supported by the structural framework is an outer protective cover that includes a grille portion providing the necessary air inlet and outlet openings for air cooling of the condenser coils, and outer doors that may be opened to provide access to the interior of the unit for maintenance.

Such refrigeration units should be able to be manufactured without undue difficulty, should be as light in weight as possible while having adequate structural strength, and should provide adequate refrigerant capacity for their intended service.

Looking now to the outer cover of such units it is considered desirable to provide components that are lower in cost and weight while at the same time displaying improved quality, appearance and reliability. It is also desirable to provide such components that are made from fewer parts, thus facilitating handling at the assembly.

While these devices fulfill their respective, particular objective and requirements, the aforementioned art does not describe an extremely simple outer cover or shield for refrigeration unit that is easy to install and uninstall using bolts. Therefore, it can be appreciated that there exists a continuing need for a new and improved shield or outer protective covers that protect the refrigeration unit. In this regard, the present invention substantially fulfills this need.

### SUMMARY OF THE INVENTION

In the view of the foregoing disadvantages inherent in the known types of shield or outer protective covers that cover the refrigeration unit now present in the prior art, the present invention provides an improved shield or outer protective covers that cover the refrigeration unit, the general purpose of the present invention, which will be described subsequently in greater detail, is to provide a new and improved shield or outer protective covers that cover the refrigeration unit which has all the advantages of the prior art and none of the disadvantages.

An outer protective shield for a refrigeration unit on a transportation truck, comprising: an framed structure designed and shaped to fit around the refrigeration unit; a plurality of attachment devices, coupling the aluminum framed structure to the transportation truck; a flat thin shield, mounted over a front side of the framed structure and prevent air from flowing therethrough, but not covering side and top portions of the framed structure to allow air to have access to the refrigeration unit; an pair of angled flaps, coupled to and extending along en entire length of a top and bottom edge of the flat thin shield, and forming an angle toward the transportation truck along its entire length thereof.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty that characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a perspective side view of the metal mount of the invention.

FIG. 2 shows a perspective front view of the metal mount of the invention.

### DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

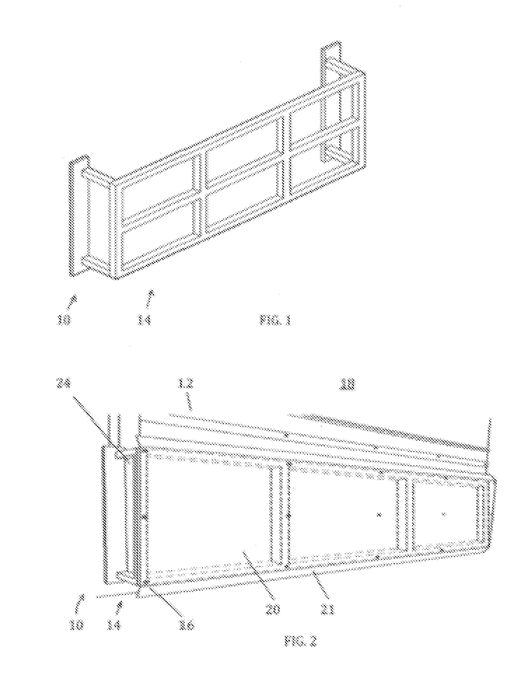

Referring now to FIGS. 1 and 2, which illustrate perspective views of the protective shielding that is designed to fit over the exposed portions of the typical refrigeration units mounted to a top portion of the truck that faces forward and is located above the cab of the truck. In other words, this invention relates primarily to an outer protective cover for shielding the refrigeration unit that may also prevent forklifts from damaging the refrigeration units. The outer protective cover 10 for shielding the refrigeration unit 12, has a frame 14 that may be made of metal, like aluminum, and attached, potentially using bolts 16, to the truck 18, thereby covering the refrigeration unit 12. The protective shield 20 is in the form of a large metal shield to protect a refrigeration unit in a transportation truck. Typical shields may be constructed of aluminum components and are attached by attachment devices, like boltes 16, to the transportation truck 18. Advantages of the invention include safeguarding the refrigeration unit from damage caused by a forklift. The shield 20 may have extended flaps 21 on a top and bottom location extending off and away of the frame 14, and angled toward the truck body 18.

The outer protective shield is in the shape of a rectangle with various aluminum bars welded at vertices to form a cage as shown in FIGS. 1 and 2. The size of the shield of the invention varies as per user's requirement and can be tailor made different sizes of refrigeration units.

The outer protective shield surrounds a refrigeration unit and protects it from heavy impact damage, such as that which would be likely from low hanging objects and tree limbs in a moving truck. The shield is constructed from materials and components which impart a structural rigidity and strength to the shield. The refrigeration unit shield device provides large open areas of access 24 for maintenance of the refrigeration unit.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. An outer protective shield for a refrigeration unit on a transportation truck, comprising:
a. an framed structure designed and shaped to fit around the refrigeration unit;
b. a plurality of attachment devices, coupling the aluminum framed structure to the transportation truck;
c. a flat thin shield, mounted over a front side of the framed structure and prevent air from flowing therethrough, but not covering side and top portions of the framed structure to allow air to have access to the refrigeration unit;
d. an pair of angled flaps, coupled to and extending along en entire length of a top and bottom edge of the flat thin shield, and forming an angle toward the transportation truck along its entire length thereof.
